(19) United States
(12) Patent Application Publication
(10) Pub. No.: US 2026/0317511 A1
(43) Pub. Date: Oct. 15, 2026

(54) PHOTOCURABLE RESIN COMPOSITION, MOLDED ARTICLE OBTAINED THEREFROM, AND ELECTRICAL COMPONENT

(71) Applicant: Enplas Corporation, Saitama (JP)

(72) Inventors: Reo TAKAIWA, Saitama (JP); Nanako SAKAI, Saitama (JP); Yohei TSURUMAKI, Saitama (JP)

(21) Appl. No.: 19/570,455

(22) Filed: Mar. 18, 2026

(30) Foreign Application Priority Data
Apr. 9, 2025 (JP) 2025-064284

(51) Int. Cl. C08K 3/36; C08L 33/08

(52) U.S. Cl. CPC C08K 3/36; C08L 33/08; C08K 2201/003; C08L 2203/20

(57) ABSTRACT

An object of the present invention is to provide a photocurable resin composition for obtaining a molded article having high strength, a low coefficient of thermal expansion, and abrasion resistance. A photocurable resin composition that achieves the above object contains a polyfunctional acrylic resin (A) containing a polycyclic aliphatic acrylic resin (A1) and an isocyanuric acid acrylic resin (A2), and silica particles (B). The amount of (A1) component based on the total amount of (A) component is 20-80% by mass, the amount of (A2) component based on the total amount of (A) component is 20-80% by mass, the amount of the silica particles (B) based on the total amount of the resin composition is 20-40% by mass. The average primary particle diameter of the silica particles (B) is 100 nm or less, and the aggregated particle diameter of the silica particles (B) measured is 3-50 μm.

### CROSS REFERENCE TO RELATED APPLICATIONS

Japanese Patent Application No. 2025-064284 filed on Apr. 9, 2025, including description, claims, and abstract the entire disclosure is incorporated herein by reference in its entirety.

### TECHNICAL FIELD

The present invention relates to a photocurable resin composition, a molded article including the same, and an electrical component.

### BACKGROUND ART

In recent years, a molding method using a 3D printer is known as a method for manufacturing components or products having various shapes. Among various molding methods, a stereolithographic molding method using a photocurable resin composition including a photocurable resin has an advantage that a resin can be quickly cured into a desired shape. Various resins have been proposed as the photocurable resin used in the stereolithographic molding method. For example, it has been proposed to use an acrylate having an isocyanuric ring in stereolithography (for example, Japanese Patent Application Laid-Open No. 2022-70123)

However, a resin molded article obtained only from a photocurable resin often has insufficient mechanical strength or the like, and thus improvement is required. To address such a problem, it has been proposed to add a filler to a photopolymerizable resin composition to increase the mechanical strength thereof (for example, Japanese Patent Application Laid-Open No. 2023-140203).

### SUMMARY OF INVENTION

### Technical Problem

However, in a molded article containing fillers, the particle diameter or the aggregation state of the fillers may actually affect properties such as lowering mechanical strength and reducing abrasion resistance. In addition, depending on the particle diameter or the like of the fillers, the effect of reducing thermal expansibility may not be sufficiently obtained.

An object of the present invention is to provide a molded article having high strength, low coefficient of thermal expansion, and satisfactory abrasion resistance, a photocurable resin composition for obtaining the molded article, and an electrical component.

### Solution to Problem

The present invention provides the following photocurable resin compositions.

[1]A photocurable resin composition including: a polyfunctional acrylic resin (A) containing a polycyclic aliphatic acrylic resin (A1) and an isocyanuric acid acrylic resin (A2); and silica particles (B), in which
an amount of the polycyclic aliphatic acrylic resin (A1) based on a total amount of the polyfunctional acrylic resin (A) is 20% by mass or more and 80% by mass or less; an amount of the isocyanuric acid acrylic resin (A2) based on the total amount of the polyfunctional acrylic resin (A) is 20% by mass or more and 80% by mass or less; an amount of the silica particles (B) based on a total amount of the photocurable resin composition is 20% by mass or more and 40% by mass or less; an average primary particle diameter of the silica particles (B) observed with a transmission electron microscope is 100 nm or less; and when, at two locations in a cross section of a cured product of the photocurable resin composition, aggregated particles of the silica particles (B) are observed with an optical microscope at a magnification of 200 times, diameters of aggregated particles from a largest aggregated particle to a tenth largest aggregated particle located in each of two visual fields are specified, and an average value of the diameters of a total of the 20 aggregated particles is calculated, the average value is 3 μm or more and 50 μm or less.
   [2] The photocurable resin composition according to [1], in which the silica particles (B) are surface-treated with a compound having a (meth)acryloyl group.
   [3] The photocurable resin composition according to [1] or [2], in which the polycyclic aliphatic acrylic resin (A1) is tricyclodecane dimethanol diacrylate.
   [4] The photocurable resin composition according to any one of [1] to [3], in which the isocyanuric acid acrylic resin (A2) is a compound represented by a general formula below:

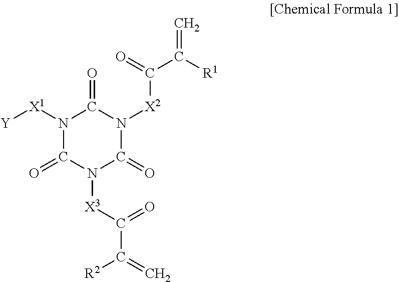

in the general formula, X¹, X², and X³ each independently represent a linking group having 1 or more and 20 or less carbon atoms and optionally containing an oxygen atom,
R¹ and R² each independently represent a hydrogen atom or a methyl group, and
Y represents a (meth)acryloyl group or a hydroxy group.

The present invention also provides the following molded article and electrical component.

[5]A molded article including a cured product of the photocurable resin composition according to any one of [1] to [4].
[6] An electrical component including the molded article according to [5].

### Advantageous Effects of Invention

The present invention can provide a molded article having high strength, low coefficient of thermal expansion, and satisfactory abrasion resistance, a photocurable resin composition for obtaining the molded article, and an electrical component.

### DESCRIPTION OF EMBODIMENTS

The photocurable resin composition according to the present invention is suitably used in a stereolithographic molding method for manufacturing a molded article by irradiation with light. Therefore, hereinafter, the photocurable resin composition will be described using a photocurable resin composition in a stereolithographic molding method as an example. However, the use of the photocurable resin composition according to the present invention is not limited thereto.

As described above, it has been considered to add a filler to a photocurable resin composition, but it is difficult to obtain a cured product having high strength, low coefficient of thermal expansion, and satisfactory abrasion resistance by simply adding a filler. As a result of intensive studies on the above-described problem, the present inventors have found that, when general nanosilica having an average primary particle diameter of several nanometers to several hundred nanometers is added to a photocurable resin composition, the abrasion resistance and strength of a cured product obtained from the photocurable resin composition are increased, but it is difficult to sufficiently obtain a reduction effect of the coefficient of thermal expansion. Further, when a large amount of nanosilica is added, the photocurable resin composition is more likely to thicken, and it becomes difficult to obtain a desired molded article. In addition, when microsilica having an average primary particle diameter of several microns to several hundred microns is added to a photocurable resin composition, the coefficient of thermal expansion of the cured product is reduced, but the abrasion resistance of the cured product is more likely to decrease. This is considered to occur because the silica particles detach or scrape the contacted member when they contact other members.

To address such a problem, the photocurable resin composition according to the present invention contains a polyfunctional acrylic resin (A) and silica particles (B), and satisfies the following five conditions (i) to (v).
(i) The polyfunctional acrylic resin (A) contains 20% by mass or more and 80% by mass or less of a polycyclic aliphatic acrylic resin (A1).
(ii) The polyfunctional acrylic resin (A) contains 20% by mass or more and 80% by mass or less of an isocyanuric acid acrylic resin (A2).
(iii) The amount of the silica particles (B) is 20% by mass or more and 40% by mass or less based on the total amount of the photocurable resin composition.
(iv) The average primary particle diameter of the silica particles (B) observed with a transmission electron microscope is 100 nm or less.
(v) At two locations a cross section of a cured product of the photocurable resin composition, when aggregated particles of the silica particles (B) are observed with an optical microscope at a magnification of 200 times, diameters of the largest aggregated particles to the tenth largest aggregated particles located in each visual field are specified, and an average value of the diameters of the total of the 20 aggregated particles is calculated, the average value is 3 μm or more and 50 μm or less.

The photocurable resin composition according to the present invention has the following features: as shown in condition (iii), the photocurable resin composition includes a certain amount of silica particles (B); as shown in conditions (iv) and (v), the average primary particle diameter of the silica particles (B) is 100 nm or less; and the average value of the diameters of relatively large aggregated particles generated by aggregation of the silica particles (B) falls within a predetermined range. That is, a cured product of the photocurable resin composition according to the present invention includes a predetermined amount of aggregated particles of an appropriate size generated by aggregation of sufficiently small silica particles (B). Therefore, as shown in Examples described below, it is considered that the coefficient of thermal expansion of the cured product is reduced, the strength thereof is increased, or the abrasion resistance thereof is improved.

In the photocurable resin composition according to the embodiment of the present invention, as shown in the conditions (i) and (ii), the polyfunctional acrylic resin (A) contains a predetermined amount of the polycyclic aliphatic acrylic resin (A1) and a predetermined amount of the isocyanuric acid acrylic resin (A2). When the polycyclic aliphatic acrylic resin (A1) and the isocyanuric acid acrylic resin (A2) are combined, these resins interact with each other to form an acrylic network. Therefore, in the cured product of the photocurable resin composition according to the present invention, a higher strength, a lower coefficient of thermal expansion, and higher abrasion resistance are achieved by the network.

The photocurable resin composition according to the present invention includes at least the above polyfunctional acrylic resin (A) and the silica particles (B), but typically also includes a photopolymerization initiator (C). Hereinafter, each component contained in the photocurable resin composition will be described in detail.

### (A) (Polyfunctional Acrylic Resin)

In the present specification, the polyfunctional acrylic resin (A) refers to a resin having two or more (meth)acryloyl groups in one molecule. In addition, in the present specification, the term “(meth)acryloyl” means methacryloyl, acryloyl, or both. The same applies to the (meth)acrylate.

As described above, the polyfunctional acrylic resin (A) contains at least the polycyclic aliphatic acrylic resin (A1) and the isocyanuric acid acrylic resin (A2). In a range not impairing the object and effect of the present invention, the polyfunctional acrylic resin (A) may further contain a known bifunctional or higher functional acrylic resin (for example, a pentaerythritol-type acrylic resin) other than the polycyclic aliphatic acrylic resin (A1) and the isocyanuric acid acrylic resin (A2). However, the sum of the mass of the polycyclic aliphatic acrylic resin (A1) and the mass of the isocyanuric acid acrylic resin (A2) is 40% by mass or more, preferably 80% by mass or more, and more preferably 90% by mass or more, based on the total mass of the polyfunctional acrylic resin (A). When the sum of the mass of the polycyclic aliphatic acrylic resin (A1) and the mass of the isocyanuric acid acrylic resin (A2) is within the range, the amount of the above-described network is sufficiently increased, and the strength of the molded article to be obtained is more likely to be further increased.

In addition, the total mass of the polyfunctional acrylic resin (A) in the photocurable resin composition is preferably 60% by mass or more and 80% by mass or less, and more preferably 65% by mass or more and 75% by mass or less. When the amount of the polyfunctional acrylic resin (A) is 60% by mass or more, the silica particles (B) are easily bound, and the strength of the photocurable resin composition is more likely to be further increased. On the other hand, when the amount of the polyfunctional acrylic resin (A) is 80% by mass or less, the amounts of the silica particles (B) and the photopolymerization initiator (C) described below become relatively large. As a result, the coefficient of thermal expansion of the cured product is further reduced, or the photocurability of the photocurable resin is improved.

### (A1) Polycyclic Aliphatic Acrylic Resin

In the present specification, the term “polycyclic aliphatic acrylic resin” refers to a resin having a polycyclic aliphatic structure and two or more (meth)acryloyl groups. The polycyclic aliphatic acrylic resin (A1) may be a monomer, an oligomer, or a polymer, but from the viewpoint of the viscosity of the photocurable resin composition and the interaction with the isocyanuric acid acrylic resin (A2) described below, the polycyclic aliphatic acrylic resin (A1) is preferably a monomer. The polyfunctional acrylic resin (A) may contain only one type of the polycyclic aliphatic acrylic resin (A1), or two or more types thereof.

Herein, the number of rings in the polycyclic aliphatic structure is 2 or more, and is preferably 2 to 5, more preferably 2 to 4, and still more preferably 2 or 3. Examples of the polycyclic aliphatic structure include condensed polycyclic cycloalkane structures such as bicycloundecane, tricyclodecane, norbornane, adamantane, and decahydronaphthalene; and a spirocyclic cycloalkane structures such as spiro[3.4]octane, spiro[4.4]nonane, and spiro[4.5]decane. Among these, the polycyclic aliphatic structure is preferably a condensed polycyclic cycloalkane structure, and more preferably a tricyclodecane structure.

The number of (meth)acryloyl groups is 2 or more, and is preferably 2 to 6, more preferably 2 to 4, and still more preferably 2 or 3. The (meth)acryloyl group may be directly bonded to the polycyclic aliphatic structure, or may be bonded to the polycyclic aliphatic structure via a linking group such as an alkylene group or an alkyleneoxy group.

Specific examples of the polycyclic aliphatic acrylic resin (A1) include tricyclodecane dimethanol di(meth)acrylate, adamantane diol di(meth)acrylate, and adamantane triol di(meth)acrylate. Among these, from the viewpoint of facilitating the formation of the above-described network by interacting with the isocyanuric acid acrylic resin (A2) described below, tricyclodecane dimethanol di(meth)acrylate is particularly preferable.

The amount of the polycyclic aliphatic acrylic resin (A1) is 20% by mass or more and 80% by mass or less, and is more preferably 30% by mass or more and 70% by mass or less, based on the total mass of the polyfunctional acrylic resin (A). As described above, when the amount of the polycyclic aliphatic acrylic resin (A1) is within the above range, the strength of a cured product obtained from the photocurable resin composition is sufficiently increased.

### (A2) Isocyanuric Acid Acrylic Resin

The isocyanuric acid acrylic resin (A2) is a resin having an isocyanuric ring and two or more (meth)acryloyl groups. The isocyanuric acid acrylic resin (A2) may be a monomer, an oligomer, or a polymer, but from the viewpoint of the viscosity of the photocurable resin composition and the interaction with the polycyclic aliphatic acrylic resin (A1), the isocyanuric acid acrylic resin (A2) is preferably a monomer. The polyfunctional acrylic resin (A) may contain only one type of the isocyanuric acid acrylic resin (A2), or two or more types thereof.

Here, the number of isocyanuric rings included in the isocyanuric acid acrylic resin (A2) is 1 or more, and may be 2 or more, but is usually 1. In addition, the number of (meth)acryloyl groups included in the isocyanuric acid acrylic resin (A2) is 2 or more, and is usually 2 or 3, preferably 3. When the isocyanuric acid acrylic resin (A2) has three (meth)acryloyl groups, the isocyanuric acid acrylic resin easily forms the above-described network in the cured product, and the strength of the cured product (molded article) is more likely to be further increased.

Examples of the isocyanuric acid acrylic resin (A2) include compounds represented by the following general formula.

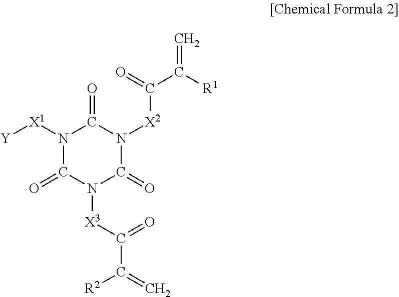

In the general formula, X¹, X², and X³ each independently represent a linking group having 1 or more and 20 or less carbon atoms and optionally containing an oxygen atom. X¹, X², and X³ may be the same or different from each other. Specific examples of the linking group which may be X¹, X², and X³ include alkylene groups represented by —(CₙH₂ₙ)— (n is 1 or more and 10 or less, preferably 1 or more and 6 or less, and more preferably 2 or 3); (poly)alkyleneoxy groups represented by —(CₙH₂ₙO)ₘ— (n is 1 or more and 10 or less, preferably 1 or more and 6 or less, and more preferably 2 or 3, and m is 1 or more and 10 or less, preferably 1 or more and 6 or less, and more preferably 1 or more and 3 or less); groups derived from F-caprolactone represented by —(C(═O)C₅H₂ₙO)ₘ— (m is 1 or more and 3 or less, preferably 1 or 2); and combinations thereof. In addition, a substituent such as a hydroxy group may be bonded to the linking group. Among these, the linking group is particularly preferably ethyleneoxy group represented by —(C₂H₄O)—.

In the general formula, R¹ and R² each independently represent a hydrogen atom or a methyl group. R¹ and R² may be the same or different from each other. Further, in the general formula, Y represents a (meth)acryloyl group or a hydroxy group.

The isocyanuric acid acrylic resin (A2) may be a synthetic product or a commercially available product. Examples of commercially available products of the isocyanuric acid acrylic resin (A2) having three (meth)acryloyl groups include NK ESTER A-9300S and NK ESTER A-9300-1CL (both manufactured by Shin-Nakamura Chemical Co., Ltd.) and ARONIX M-327 (manufactured by TOAGOSEI CO., LTD.). In addition, examples of commercially available products of the isocyanuric acid acrylic resin (A2) having two (meth)acryloyl groups include ARONIX M-215 (manufactured by TOAGOSEI CO., LTD.). Further, examples of commercially available products of a mixture of the isocyanuric acid acrylic resin (A2) having three (meth)acryloyl groups and the isocyanuric acid acrylic resin (A2) having two (meth)acryloyl groups include ARONIX M-313 and ARONIX M-315 (both manufactured by TOAGOSEI CO., LTD.).

Among these, the isocyanuric acid acrylic resin (A2) is particularly preferably a compound represented by the following formula from the viewpoint of easily forming a desired network by interacting with the polycyclic aliphatic acrylic resin (A1).

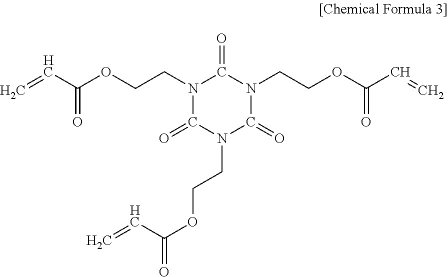 [SMILES: C=CC(=O)OCCn1c(=O)n(CCOC(=O)C=C)c(=O)n(CCOC(=O)C=C)c1=O]

The amount of the isocyanuric acid acrylic resin (A2) is 20% by mass or more and 80% by mass or less, and is more preferably 30% by mass or more and 70% by mass or less, based on the total mass of the polyfunctional acrylic resin (A). As described above, when the amount of the isocyanuric acid acrylic resin (A2) is within the range, the strength of the cured product (molded article) to be obtained from the photocurable resin composition is more likely to be further increased.

### (B) Silica Particles

Silica particles (B) are particles containing silica having an average primary particle diameter of 100 nm or less, as observed with a transmission electron microscope, as described above. In the present specification, the average primary particle diameter of the silica particles (B) refers to the average primary particle diameter of the silica particles (B) in a state of powder before being mixed with the above polyfunctional acrylic resin (A) and the like. The average primary particle diameter is specifically measured by the following method. An image of a plurality of silica particles in a dry state is captured by a transmission electron microscope. Twenty silica particles are randomly selected from the obtained image, and the diameter of each particle is specified. When the shape of each silica particle is not a perfect circle in the captured image, the measured maximum diameter of each particle is used as the major axis, and the measured diameter orthogonal to the major axis is used as the minor axis. Then, the value of (major axis+minor axis)/2 is adopted as the particle diameter of the particle. Then, the average value of the particle diameters of the 20 silica particles is used as the average primary particle diameter of the silica particles (B).

The average primary particle diameter of the silica particles (B) is 100 nm or less. As described above, when the average primary particle diameter of the silica particles (B) is 100 nm or less, the silica particles (B) are less likely to scrape another member when the cured product of the photocurable resin composition is rubbed against this member, and thus the abrasion resistance is improved. In addition, even when the silica particles (B) are rubbed off against another member and fall off, the fallen portion is small, and thus the strength of the cured product is less likely to be affected. The average primary particle diameter of the silica particles (B) is preferably 1 nm or more and 100 nm or less, more preferably 3 nm or more and 50 nm or less, and still more preferably 5 nm or more and 20 nm or less. The shape of the primary particles of the silica particles (B) is not particularly limited, but is preferably spherical.

In addition, the average value of the diameters of the aggregated particles of the silica particles (B) is 3 μm or more and 50 μm or less. The average of the diameters of aggregated particles of the silica particles (B) can be measured by the following method. At two locations in at least one cross section of a cured product obtained from the photocurable resin composition, the aggregated particles of the silica particles (B) are observed with an optical microscope at a magnification of 200 times, the diameters of the aggregated particles from the largest aggregated particle to the tenth largest aggregated particle located in each of two visual fields are specified, and the average value of the diameters of the total of the 20 aggregated particles is calculated. The average value (hereinafter, the average value is also referred to as the “aggregated particle diameter”) is used as the average diameter of the aggregated particles.

The details of the method for measuring the aggregated particle diameter are as follows. First, the photocurable resin composition is irradiated with light having a wavelength of 365 nm for 5 seconds to cure the photocurable resin composition, and a plate-shaped sample having a thickness of 1 mm is produced. The obtained plate-shaped sample (cured product) is embedded in a resin, and then the resulting embedment is polished so that a cross section of the cured product is exposed. Images of two locations in the exposed cured product are captured with an optical microscope at a magnification of 200 times. Aggregated particles of the silica particles (B) located in the visual field of each of the obtained two images are observed, and the diameters of the aggregated particles from the largest aggregated particle to the tenth largest aggregated particle are specified. In the obtained image, when an aggregated particle is not perfectly circular, the maximum diameter of the aggregated particle is used as the major axis, and the diameter orthogonal to the major axis is used as the minor axis. Then, the value of (major axis+minor axis)/2 is used as the diameter of the aggregated particle. Then, the average value of the diameters of these 20 aggregated particles is calculated, and this average value is used as the aggregated particle diameter.

When the aggregated particle diameter obtained by the above-described method is 3 μm or more and 50 μm or less, as described above, the bending strength and abrasion resistance of the obtained cured product are improved, and further, a low coefficient of thermal expansion is achieved. The aggregated particle diameter is preferably 4 μm or more and 40 μm or less, and more preferably 5 μm or more and 35 μm or less.

The aggregating properties of the silica particles (B) can be adjusted by surface treatment or the like of the silica particles (B). Examples of the silica particles (B) having such aggregating properties include fumed silica whose surface has been modified with a silane coupling agent.

The type of the silane coupling agent is not particularly limited as long as it has affinity with the polyfunctional acrylic resin (A) and the silica particles (B) and can appropriately aggregate the silica particles (B). Examples of the silane coupling agent include amino group-containing silane coupling agents such as N-(2-aminoethyl)-3-aminopropyltrimethoxysilane, N-(2-aminoethyl)-3-aminopropyltriethoxysilane, 3-aminopropyltrimethoxysilane, and 3-aminopropyltriethoxysilane; vinyl group-containing silane coupling agents such as vinyltrimethoxysilane, vinyltriethoxysilane, and diethoxymethylvinylsilane; (meth)acryloyl group-containing silane coupling agents such as 3-methacryloxypropyltrimethoxysilane, 3-methacryloxypropyltriethoxysilane, and 3-acryloxypropyltrimethoxysilane; isocyanate group-containing silane coupling agents such as 3-isocyanatopropyltriethoxysilane; epoxy group-containing silane coupling agents such as 3-glycidoxypropyltrimethoxysilane and 3-glycidoxypropyltriethoxysilane; ureido group-containing silane coupling agents such as 3-ureidopropyltriethoxysilane; and mercapto group-containing silane coupling agents such as 3-mercaptopropyltrimethoxysilane. These silane coupling agents can be used alone or in combination of two or more types thereof.

Among the above-described silane coupling agents, a compound having a (meth)acryloyl group, that is, a (meth)acryloyl group-containing silane coupling agent is preferable from the viewpoint that the affinity with the polyfunctional acrylic resin (A) is satisfactory and the above-described aggregated particle diameter is easily obtained. In addition, when the silane coupling agent has a (meth)acryloyl group, the silane coupling agent polymerizes with the above-described polyfunctional acrylic resin (A). As a result, the aggregated particles of the silica particles (B) are more likely to be uniformly dispersed in the polyfunctional acrylic resin (A). Examples of the silica particles (B) that can easily obtain the above-described aggregated particle diameter include AEROSIL R7200 (product name) manufactured by Nippon Aerosil Co., Ltd.

The amount of the silica particles (B) is 10% by mass or more and 40% by mass or less, and is preferably 20% by mass or more and 38% by mass or less, based on the total mass of the photocurable resin composition. As described above, when the amount of the silica particles (B) is within the above-described range, the thermal expansibility of the obtained molded article is sufficiently reduced, and further, the strength of the obtained molded article is increased or the abrasion resistance thereof is improved.

### (C) Photopolymerization Initiator

The photopolymerization initiator (C) is a compound that can generate an active species by absorbing light (for example, ultraviolet light or visible light, which is emitted when curing the photocurable resin composition), and initiate polymerization of the above-described polyfunctional acrylic resin (A) or the like. The photocurable resin composition may contain only one type of the photopolymerization initiator (C), or two or more types thereof.

Examples of the photopolymerization initiator (C) include alkylphenone-based radical polymerization initiators, acylphosphine oxide-based radical polymerization initiators, and oxime ester-based radical polymerization initiators. Examples of the alkylphenone-based photopolymerization initiator include 2,2-dimethoxy-1,2-diphenylethane-1-one, 1-hydroxy-cyclohexyl-phenyl-ketone, 2-hydroxy-2-methyl-1-phenyl-propane-1-one, 1-[4-(2-hydroxyethoxy)-phenyl]-2-hydroxy-2-methyl-1-propane-1-one, 2-hydroxy-1-{4-[4-(2-hydroxy-2-methyl-propionyl)-benzyl]phenyl}-2-methyl-propane-1-one, 2-methyl-1-(4-methylthiophenyl)-2-morpholinopropane-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, and the like. Examples of the acylphosphine oxide-based photopolymerization initiator include bisphenyl(2,4,6-trimethylbenzoyl)phosphine oxide and phenylbis(2,4,6-trimethylbenzoyl)phosphine oxide. Examples of the oxime ester-based radical polymerization initiator include 2-benzoyloxyimino-4′-(phenylthio)octanophenone and 6-[1-(acetyloxyimino)ethyl]-9-ethyl-9H-carbazole-3-yl-2-methylphenyl ketone.

The amount of the photopolymerization initiator (C) in the photocurable resin composition is preferably 0.5 parts by mass or more and 3.0 parts by mass or less, and more preferably 0.7 parts by mass or more and 2.0 parts by mass or less, based on 100 parts by mass of the total mass of the photocurable resin (the above-described polyfunctional acrylic resin (A) or the like). When the amount of the photopolymerization initiator (C) is within the above-described range, it is possible to efficiently cure the photocurable resin composition.

### (D) Additional Components

In a range not impairing the object and effect of the present invention, the photocurable resin composition may further contain a component other than the polyfunctional acrylic resin (A), the silica particles (B), and the photopolymerization initiator (C). Examples of the additional components include photocurable resins other than the polyfunctional acrylic resin (A) (for example, monofunctional acrylic resins), other curable resins such as epoxy resins, and various additives. Examples of the additives include dispersion stabilizers, colorants, UV absorbers, antioxidants, polymerization inhibitors, antifoaming agents, fillers, photosensitizers, and toughening agents.

### (Viscosity of Photocurable Resin Composition)

The viscosity of the photocurable resin composition is appropriately selected depending on the type of stereolithographic molding method. For example, usually in a laminating type stereolithographic molding method described below, the viscosity of the photocurable resin composition at 25° C. is preferably 1 Pa·s or more and 1,000 Pa·s or less, and more preferably 10 Pa·s or more and 800 Pa·s or less. The viscosity is measured by rotating a sample at a shear rate of 1 (1/s) using a rheometer (for example, Discovery HR-2 manufactured by TA Instruments) and reading the value after the rotation has stabilized (for example, after 90 seconds). When the viscosity of the photocurable resin composition is within the range, the fluidity of the photocurable resin composition during stereolithography is more likely to become suitable.

### (Method for Preparing Photocurable Resin Composition)

The method for preparing the above-described photocurable resin composition is not particularly limited as long as the polyfunctional acrylic resin (A), the silica particles (B), the photopolymerization initiator (C), and other components as necessary can be uniformly mixed. For example, all components may be mixed at once. On the other hand, the polyfunctional acrylic resin (A) and the photopolymerization initiator (C) may be mixed first, and then the silica particles (B) and other components may be mixed. The mixing method can be the same as a known stirring method or kneading method.

### (Stereolithographic Molding Method Using Photocurable Resin Composition)

The photocurable resin composition can be used in various stereolithographic molding methods. An example of the stereolithographic molding method is the following laminating type stereolithographic molding method.

In this method, the photocurable resin composition is supplied onto a stage to form a layer (first layer) having a desired thickness and composed of the photocurable resin composition. At this time, the method for supplying the photocurable resin composition is not particularly limited, and for example, a method using a T-die can be used. In addition, the surface of the photocurable resin composition supplied from the T-die may be smoothed with a squeegee, a doctor knife, or the like as necessary. Then, a predetermined region of the first layer composed of the photocurable resin composition is irradiated with light to cure the photocurable resin composition in the irradiated region. The method for irradiating the region with light is not particularly limited, and for example, laser light may be scanned, or exposure may be performed all at once through a mask or the like. At this time, the wavelength of the light used for irradiation is not particularly limited, and is appropriately selected depending on the type of photopolymerization initiator described above, but for example, light having a wavelength of 100 nm or more and 405 nm or less is preferable.

The photocurable resin composition is further supplied onto the cured product of the first layer to form a layer (second layer) having a desired thickness. Then, a desired region of the second layer is irradiated with light in the same manner as described above to cure the photocurable resin composition. By repeating these steps, a molded article including the cured product of the photocurable resin composition can be obtained.

After the production of the molded article or during the production of the molded article, a heat treatment may be performed as necessary to promote the curing of the photocurable resin composition.

### (Use of Molded Article)

A molded article including the cured product of the above-described photocurable resin composition has high mechanical strength, satisfactory abrasion resistance, and a low coefficient of thermal expansion as described above. Therefore, the molded article can be used for various use such as electrical components, electronic devices, electrical equipment, medical devices, home appliances, robot-related products, and vehicle-related products. Among these, the molded article is useful in the manufacture of electrical components in which a composite component is often manufactured by combining the molded article with metal.

### EXAMPLES

Hereinafter, the present invention will be described using Examples and Comparative examples, but the present invention is not limited to the following Examples in any way.

### 1. Preparation of Materials

The following materials were used in Examples and Comparative examples.

### (A) Polyfunctional Acrylic Resin

### (A1) Polycyclic Aliphatic Acrylic Resin

IRR-214K (tricyclodecane dimethanol diacrylate, manufactured by Daicel-Allnex Ltd.)

### (A2) Isocyanuric Acid Acrylic Resin

A-9300S (manufactured by Shin-Nakamura Chemical Co., Ltd.)

### (B) Silica Particles

R7200 (surface-treated with methacryl silane, manufactured by Nippon Aerosil Co., Ltd., product name: AEROSIL R7200)
R711 (surface-treated with methacryl silane, manufactured by Nippon Aerosil Co., Ltd., product name: AEROSIL R711)
Admafine SC2500-SMJ (manufactured by Admatechs Co., Ltd.)

### (C) Photopolymerization Initiator

Omnirad 819 (manufactured by IGM Resins B.V.)

### 2. Preparation of Photocurable Resin Composition and Production of Cured Product

### Example 1

<Preparation of Photocurable Resin Composition>

Each polyfunctional acrylic resin (A) and photopolymerization initiator (C) shown in Table 1 below were weighed and placed a beaker in the mass ratio shown in Table 1. Specifically, 70 parts by mass of the polycyclic aliphatic acrylic resin (A1) (tricyclodecane dimethanol diacrylate), 30 parts by mass of the isocyanuric acid acrylic resin (A2) (tris[2-(acryloyloxy)ethyl]isocyanurate), and 0.7 part by mass of the photopolymerization initiator (C) (phenylbis(2,4,6-trimethylbenzoyl)phosphine oxide) were weighed and placed in a beaker. These compounds were stirred while being heated at 70° C. for 30 minutes, and it was confirmed that a homogeneous solution was obtained. Thereafter, 43 parts by mass of silica particles (B) (R7200) were further added, and kneaded with a planetary mixer SK-300TVS (manufactured by SHASHIN KAGAKU Co., Ltd.) and defoamed. As a result, a photocurable resin composition was prepared.

### <Production of Molded Article (Cured Product)>

A 1 mm-thick spacer having a donut shape (a φ80 mm disk-shaped spacer with a φ50 mm hole at the center) was placed on a plate-shaped base material that had been subjected to a release treatment, and the resin composition was poured into the hole of the spacer. Thereafter, the inner half surface was masked with a black tape, and the spacer was sandwiched between the base material and a glass plate that has been subjected to a release treatment. Then, the spacer was irradiated with light having a wavelength of 365 nm from the glass plate side for 5 seconds with a UV lamp. The uncured portion was wiped off with a TechnoWipe, the uncured material was removed by air blowing, and the end surface was further wiped off with ethanol to obtain a molded article (cured product).

### Examples 2 to 4 and Comparative Examples 1 to 6

A photocurable resin composition was prepared in the same manner as in Example 1, except that the amount of the polyfunctional acrylic resin (A), the type, aggregated particle diameter, and amount of the silica particles (B), and the amount of the photopolymerization initiator (C) were changed as shown in Table 1 below, and a molded article (cured product) was further produced.

### 3. Evaluation

The primary particle diameter and the aggregated particle diameter of each type of silica particles (B) were evaluated by the method below. Further, the coefficient of thermal expansion of a cured product, the bending strength of the cured product, and the abrasion resistance of the cured product were evaluated by the methods below.

### <Measurement of Average Primary Particle Diameter of Silica Particles (B)>

An image of silica particles before being mixed with a photocurable resin or the like was captured with a transmission electron microscope. From the obtained image, 20 particles were randomly selected, and the particle diameter of each particle was measured. At this time, when a silica particle is not perfectly circular in the captured image, the maximum diameter of the particle is used as the major axis, and the diameter orthogonal to the major axis is used as the minor axis. Then, the value of (major axis+minor axis)/2 was adopted as the particle diameter of the particle. Then, the average value of the particle diameters of the 20 silica particles was used as the average primary particle diameter.

### <Measurement of Aggregated Particle Diameter of Silica Particles>

The above-described molded article was embedded in a resin, and the resulting embedment was polished to form a smooth surface on which the molded article was exposed. Then, two locations where large particles were locally concentrated on the surface were observed and images thereof were captured with an optical microscope at a magnification of 200 times. In the two captured images, the aggregated particles of the silica particles were observed, and the particle diameters from the largest particle diameter to the tenth particle diameter were specified. When an aggregated particle in the image was not perfectly circular, the maximum diameter of the aggregated particle is used as the major axis, and the length orthogonal to the major axis is used as the minor axis. Then, the value of (major axis+minor axis)/2 was adopted as the diameter of the aggregated particle. Then, the average value of the diameters of the 20 aggregated particles was used as the average particle diameter of the aggregated particles. When the aggregated particles could not be observed by optical microscope observation at 200 times, the observation was performed by increasing the magnification to 1000 times. When the aggregated particles could not be observed even at 1000 times, the aggregated particle diameter was defined as less than 3 m.

### <Measurement of Coefficient of Thermal Expansion>

Using a test piece obtained by cutting the above-described molded article to a size of 2.8 mm×15.0 mm with a small CO₂ laser processing machine HAJIME CL1 (manufactured by 0-LASER Co., Ltd.), the coefficient of thermal expansion was evaluated with a thermal analyzer Thermo Plus EV02 TMA8311/LN2 (manufactured by Rigaku Corporation) based on JIS K-7197. Specifically, the thermal analysis was performed under a nitrogen atmosphere at a load of −49.0 mN and a temperature rising rate of 5° C./min, and the coefficient of thermal expansion in a range of −40° C. to 150° C. was specified.

### <Measurement of Bending Strength>

The bending strength was measured using a universal testing machine (manufactured by Shimadzu Corporation). Specifically, the bending strength of the above-described molded article was measured by a three-point bending test at a crosshead speed of 10 mm/min using a fixture with a span of 10 mm and upper/lower indenter diameters of 0.1 mm. The number of samples N was set to 5, and the average value of the maximum stress in the test was set as the value of the bending strength.

### <Abrasion Test>

The abrasion resistance was confirmed by rubbing the end surface of the produced molded article perpendicularly to the end surface of a 0.5 mm thick plate made of anodized aluminum. When no shavings were generated from the cured product, it was evaluated as ∘; when a small amount of shavings were generated, it was evaluated as Δ; and when a large amount of shavings were generated, it was evaluated as ×. Δ and ∘ are satisfactory results.

### 4. Results

TABLE 1

| | | | | | | | Compar- | Compar- | Compar- | Compar- | Compar- | Compar- |
|---|---|---|---|---|---|---|---|---|---|---|---|---|
| | | | | | | | ative | ative | ative | ative | ative | ative |
| | | | Exam- | Exam- | Exam- | Exam- | example | example | example | example | example | example |
| | Type | Name | ple 1 | ple 2 | ple 3 | ple 4 | 1 | 2 | 3 | 4 | 5 | 6 |
| Composition | (A) | (A1) | 70 | 70 | 70 | 70 | 70 | 70 | 70 | 70 | 100 | |
| of | Poly- | IRR- | | | | | | | | | | |
| molded | functional | 214K | | | | | | | | | | |
| article | acrylic | (A2) NK | 30 | 30 | 30 | 30 | 30 | 30 | 30 | 30 | | 100 |
| | resin | ESTER | | | | | | | | | | |
| | | A-9300S | | | | | | | | | | |
| | (C) | Omnirad | 0.7 | 0.7 | 0.7 | 0.7 | 0.7 | 0.7 | 0.7 | 0.7 | 0.7 | 0.7 |
| | Photo- | 819 | | | | | | | | | | |
| | poly- | | | | | | | | | | | |
| | merization | | | | | | | | | | | |
| | initiator | | | | | | | | | | | |
| | (B) Silica | AEROSIL | 43 | 43 | 52 | 52 | | | 52 | | 43 | 43 |
| | particles | R7200 | | | | | | | | | | |
| | | AEROSIL | | | | | 43 | 25 | | | | |
| | | R711 | | | | | | | | | | |
| | | SC2500- | | | | | | | | 43 | | |
| | | SMJ | | | | | | | | | | |
| Property | Silica | Average | 12 | 12 | 12 | 12 | 12 | 12 | 12 | 500 | 12 | 12 |
| of | particle | primary | | | | | | | | | | |
| silica | diameter | particle | | | | | | | | | | |
| particles | | diameter | | | | | | | | | | |
| | | (nm) | | | | | | | | | | |
| | | Aggregated | 22 | 15 | 5 | 40 | <3 | <3 | 66 | <3 | 5 | 15 |
| | | particle | | | | | | | | | | |
| | | diameter | | | | | | | | | | |
| | | (μm) | | | | | | | | | | |

| Ratio of silica particles | | 29.9 | 29.9 | 34.1 | 34.1 | 29.9 | 19.9 | 34.1 | 29.9 | 29.9 | 29.9 |
|---|---|---|---|---|---|---|---|---|---|---|---|
| (mass %) | | | | | | | | | | | |
| Evaluation | Thermal expansion | 49 | 50 | 48 | 48 | *¹— | 54 | 48 | 50 | 52 | 43 |
| | coefficient | | | | | | | | | | |
| | Bending strength | 138 | 143 | 140 | 121 | *¹— | 85 | 74 | 148 | 96 | 98 |
| | Abrasion | ∘ | ∘ | ∘ | Δ | *¹— | *²— | Δ | x | ∘ | Δ |
| | resistance | | | | | | | | | | |

*¹No molded article could be produced due to thickening,
*²Measurement was not possible

As shown in Table 1, in Comparative examples 1 and 2, aggregated particles of silica particles could not be observed. In Comparative example 1, no molded article could be produced due to the thickening of the resin composition. On the other hand, in Comparative example 2, it is considered that a large number of voids were generated due to the thickening of the resin composition, which led to a decrease in bending strength. In addition, the abrasion resistance could not be evaluated due to the voids.

In Comparative example 3, the aggregated particle diameter of the silica particles was 50 μm or more, which was excessively large. Therefore, it is considered that the portion containing the aggregated particles was brittle and the bending strength was low. Further, it is considered that the abrasion resistance was low for the same reason. In Comparative example 4, the average primary particle diameter of the silica particles was large, and the aggregated particle diameter was small. It is considered that the silica particles with a large average primary particle diameter are easily worn and have low abrasion resistance.

In Comparative examples 5 and 6, the acrylic resin was difficult to form an appropriate network structure, and both comparative examples had low bending strength. Further, in Comparative example 6, the abrasion resistance also decreased.

On the other hand, Examples 1 to 4 including the cycloaliphatic acrylic resin and the isocyanuric acid acrylic resin in an appropriate amount ratio and having a primary particle diameter and an aggregated particle diameter of silica particles within the desired ranges, all of the evaluations, namely coefficient of thermal expansion, the bending strength, and the abrasion resistance, were excellent.

### INDUSTRIAL APPLICABILITY

According to the photocurable resin composition of the present invention, a molded article having high strength, low coefficient of thermal expansion, and satisfactory abrasion resistance is provided. The molded article can be used for various applications, for example, electrical components.

1. A photocurable resin composition, comprising:
a polyfunctional acrylic resin (A) containing a polycyclic aliphatic acrylic resin (A1) and an isocyanuric acid acrylic resin (A2); and
silica particles (B), wherein
an amount of the polycyclic aliphatic acrylic resin (A1) based on a total amount of the polyfunctional acrylic resin (A) is 20% by mass or more and 80% by mass or less,
an amount of the isocyanuric acid acrylic resin (A2) based on the total amount of the polyfunctional acrylic resin (A) is 20% by mass or more and 80% by mass or less,
an amount of the silica particles (B) based on a total amount of the photocurable resin composition is 20% by mass or more and 40% by mass or less,
an average primary particle diameter of the silica particles (B) observed with a transmission electron microscope is 100 nm or less, and
when, at two locations in a cross section of a cured product of the photocurable resin composition, aggregated particles of the silica particles (B) are observed with an optical microscope at a magnification of 200 times, diameters of aggregated particles from a largest aggregated particle to a tenth largest aggregated particle located in each of two visual fields are specified, and an average value of the diameters of a total of the 20 aggregated particles is calculated, the average value is 3 μm or more and 50 μm or less.

2. The photocurable resin composition according to claim 1, wherein
the silica particles (B) are surface-treated with a compound having a (meth)acryloyl group.

3. The photocurable resin composition according to claim 1, wherein
the polycyclic aliphatic acrylic resin (A1) is tricyclodecane dimethanol diacrylate.

4. The photocurable resin composition according to claim 1, wherein
the isocyanuric acid acrylic resin (A2) is a compound represented by a general formula below: 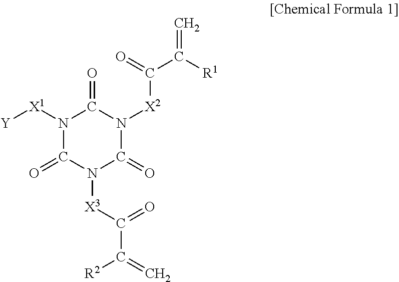
in the general formula, X¹, X², and X³ each independently represent a linking group having 1 or more and 20 or less carbon atoms and optionally containing an oxygen atom,
R¹ and R² each independently represent a hydrogen atom or a methyl group, and
Y represents a (meth)acryloyl group or a hydroxy group.

5. A molded article, comprising:
a cured product of the photocurable resin composition according to claim 1.

6. An electrical component, comprising:
the molded article according to claim 5.
